(19) United States
(12) Patent Application Publication
(10) Pub. No.: US 2004/0090655 A1
(43) Pub. Date: May 13, 2004

(54) Color image transmitting device

(75) Inventor: Osamu Kimoto, Uji-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 10/694,686

(22) Filed: Oct. 25, 2003

(30) Foreign Application Priority Data
Nov. 12, 2002 (JP) 2002-327660

(51) Int. Cl. H04N 1/46; H04N 1/64; H04N 1/32

(52) U.S. Cl. 358/500; 358/539; 358/524; 358/434

(57) ABSTRACT

An image transmitting device includes a scanner that scans an image of a document, a memory that stores scanned image data, a controller that connects to a communication medium and an extracting unit that extracts various pieces of information other than image data included in the stored image data. A converter converts the extracted various pieces of information into extracted image data and transmits the extracted image data along with the scanned image data as transmission image data.

### BACKGROUND OF THE INVENTION

1. Field of the Invention

The present invention relates to a color image transmitting device such as a facsimile machine and a multifunction peripheral which has a color image communication function.

2. Description of the Related Art

In general, there exists a color facsimile machine for transmitting and receiving a color scanned image. The color facsimile machine can transmit via a communication line, image data photographed by another device, for example, a digital camera. Conventionally, when carrying out a facsimile transmission of image data of a digital camera or the like, a memory media slot of the digital camera is connected to a facsimile machine, and YCbCr-Joint Photographic Experts Group (JPEG) image data photographed by the digital camera or the like is fetched from a memory by the memory media. Then, after expanding the image data as Red Green Blue (RGB) image data in the memory of the facsimile machine, white pixels are added so that a width of the image data includes a prescribed number of pixels. The image data is compressed into Lab-JPEG image data again, and transmitted sequentially in accordance with Information Technology—Digital Compression and coding of continuous tone still images—T81.

Moreover, there exists a facsimile machine which stores in advance as data, a name of a destination of a cover page, a section (format) for writing a name of a transmitter or the like, and finite clauses such as “Thank you” or “Sincerely”. When transmitting the cover page, a blank part of the data is filled in by inputting cover page data from an input unit to form the cover page.

When transmitting the image data photographed by the digital camera by the conventional color facsimile machine as it is, there are cases where a receiving device is not supplied with information about the transmitted image such as how the image was photographed or who photographed the image. Therefore, when transmitting a photographed image, a transmitter may form an introductory message as a heading, add the heading to the front of the photographed image, and then transmit the image. However, it is troublesome for a transmitter to form such a message. Moreover, a format or an introductory message may be stored in advance and the cover page may also be formed. However, it is necessary to input this data by using input keys.

### SUMMARY OF THE INVENTION

The present invention was made in consideration of the above-described problems. An advantage of the present invention is to provide a color image transmitting device which can automatically attach a cover page such as a heading when carrying out a facsimile transmission of an image photographed by a digital camera or the like and then transmit the image.

The color image transmitting device of the present invention includes a color image storage unit which stores scanned and input sYCC-JPEG image data, a color image transmitting unit which transmits color image data by a communication line, and an extracting unit which extracts various pieces of information other than actual image data included in the stored sYCC-JPEG image data. Before transmitting the actual image data, the extracted various pieces of information are converted into an image and transmitted.

In the color image transmitting device, various pieces of information other that the image data included in the sYCC-JPEG image data, for example, a name of a photographer, a photographed time, a photographing device or the like, are extracted and converted into an image to be transmitted as a cover page. As a result, an operator is not required to input data to form a cover page at the time of transmission.

Moreover, when transmitting an image of multiple numbers of pages at once, the color image transmitting device of the present invention can add page numbers to the pages by including page number data in the extracted information, and transmit the image.

### BRIEF DESCRIPTION OF DRAWINGS

FIG. 1 is a block diagram showing a configuration of a multifunction peripheral which is an embodiment of a color image transmitting device of the present invention.

FIG. 2 is a flowchart showing a transmission process of the multifunction peripheral according to the embodiment.

FIG. 3 is a flowchart showing the transmission process of the multifunction peripheral according to the embodiment.

FIG. 4 shows an example of a SYCC-JPEG file in the multifunction peripheral according to the embodiment.

FIG. 5 shows an example of a cover page transmitted by the multifunction peripheral according to the embodiment.

### DETAILED DESCRIPTION OF THE PREFERRED EMBODIMENTS

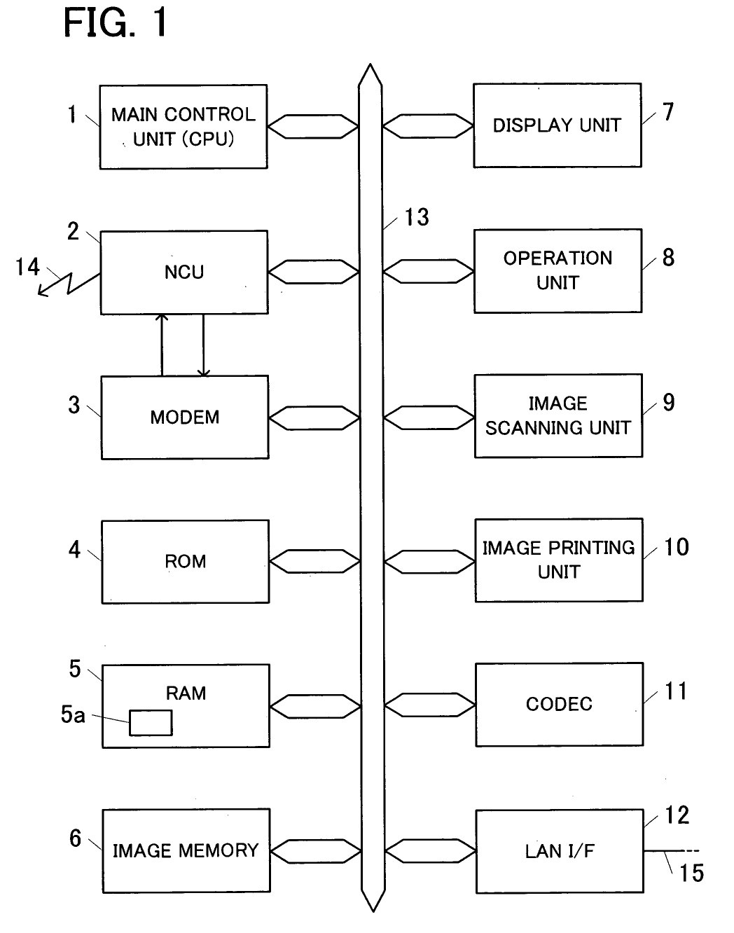

An embodiment of the present invention will be described in detail. FIG. 1 is a block diagram showing a schematic configuration of the entire color image transmitting device according to an embodiment of the present invention.

The color image transmitting device of the present embodiment is formed as a so-called color multifunction peripheral having a facsimile function and a copy function. The color image transmitting device includes a main control unit 1, a Network Control Unit (NCU) 2, a modem 3, a Read Only Memory (ROM) 4, a Random Access Memory (RAM) 5, an image memory 6, a display unit 7, an operation unit 8, an image scanning unit 9, an image printing unit 10, a Coder and Decoder (CODEC) 11, a Local Area Network InterFace (LAN I/F) 12, and a bus 13.

The main control unit (Central Processing Unit (CPU)) 1 includes a function for controlling each of the parts of the color image transmitting device. The NCU 2 includes a function for controlling a connection with a Public Switched Telephone Network (PSTN) 14, which is a communication network, and transmitting a dial signal according to a telephone number (including facsimile number) of a receiving device, and a function for detecting an incoming call. The modem 3 modulates transmission data and demodulates received data in accordance with V.17, V.27ter, V.29 or the like based on a facsimile transmission control protocol following the International Telecommunication Union-Telecommunications (ITU-T) Recommendations T.30, T.4 or the like. Alternatively, the modem 3 also modulates transmission data and demodulates received data in accordance with V.34 in addition to the ones mentioned above.

The ROM 4 stores programs for controlling the color image transmitting device. The RAM 5 temporarily stores data or the like. The RAM 5 includes a storage unit 5a for storing a sYCC-Joint Photographic Experts Group (JPEG) file.

The image memory 6 temporarily stores received image data or image data scanned by the image scanning unit 9. The display unit (Liquid Crystal Display (LCD)) 7 displays icons and key buttons, and displays messages or the like that are necessary for the transmission and reception of data. The operation unit 8 includes a one-touch key, an enter key, an operation mode switching key, a ten-key numeric pad, a start key, and other various keys. Further, the operation mode switching key switches modes between a plurality of operation modes such as a FAX mode, a copy mode, and a scanner mode. The image scanning unit 9 optically scans image data of an original document when carrying out a FAX transmission or copying. The image scanning unit 9 can also scan a color image. The image printing unit 10 is formed from an electro-photographic typed printer, and prints out onto a recording paper, received image data or image data of an original document scanned by the image scanning unit 9 in a copy operation. The image printing unit 10 can also carry out color printing.

The CODEC 11 encodes the scanned image data for transmitting or storing in accordance with Modified Huffman (MH), Modified Read (MR), Modified Modified Read (MMR) methods or the like, and decodes the received image data for printing. The LAN I/F 12 is connected to a Personal Computer (PC) and other remote devices which form a LAN 15. The color image transmitting device exchanges data with a remote device via the LAN I/F 12. When the color image transmitting device receives a request from a remote PC to forward data such as a JPEG file, the JPEG image data of the storage unit 5a is forwarded to the remote PC via the LAN I/F 12 and the LAN 15.

A color image photographed by a digital camera or the like is stored in the storage unit 5a as a sYCC-JPEG file. Moreover, in place of the storage unit 5a of the RAM 5, the sYCC-JPEG file can be stored in another storage unit which can be accessed under the control of the main control unit 1.

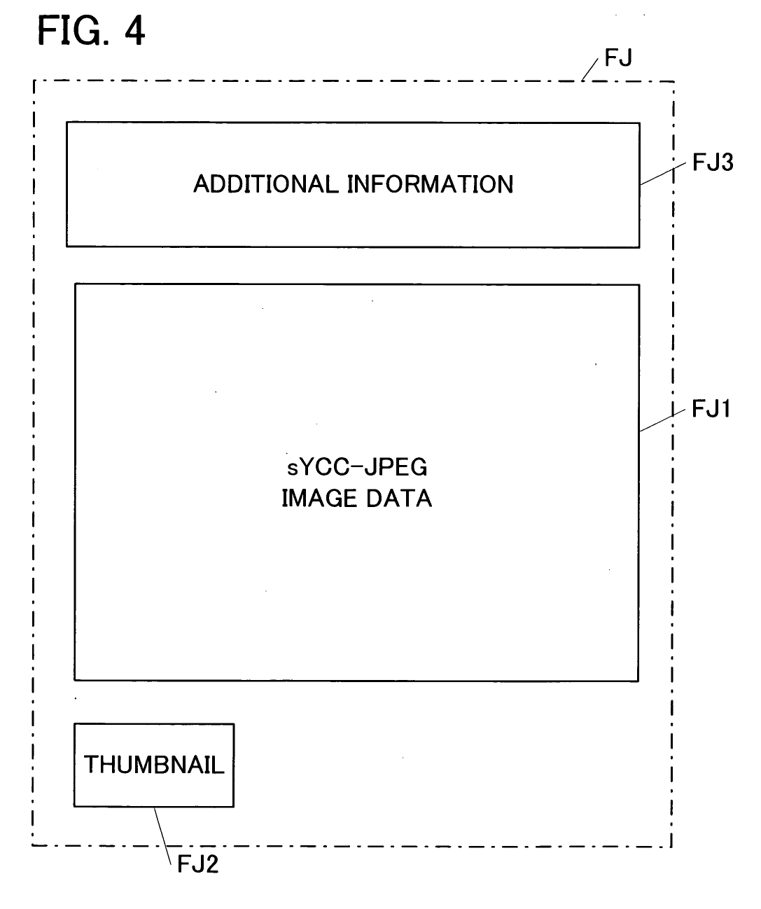

As shown in FIG. 4, a sYCC-JPEG file FJ is formed from a photographed image (actual image) FJ1 photographed by the digital camera, a thumbnail of the photographed image FJ2, and additional information FJ3. Additional information FJ3 includes the name of the photographer, information about the photographer, the photographed time, and related data of the photographing device or the like.

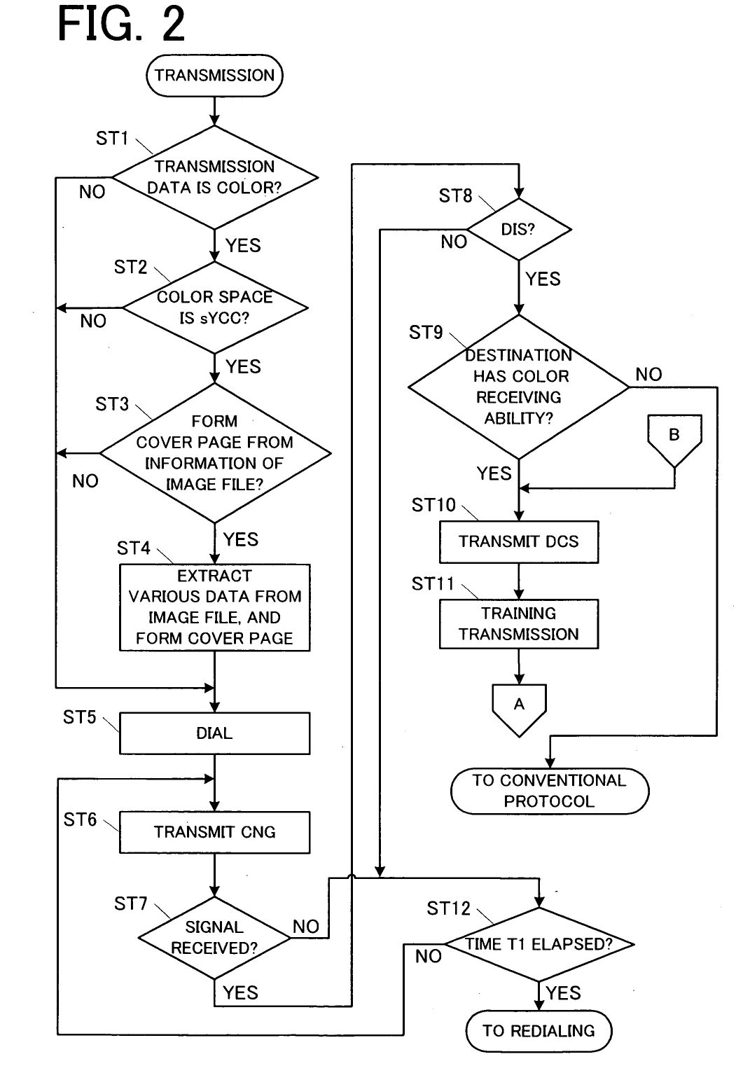

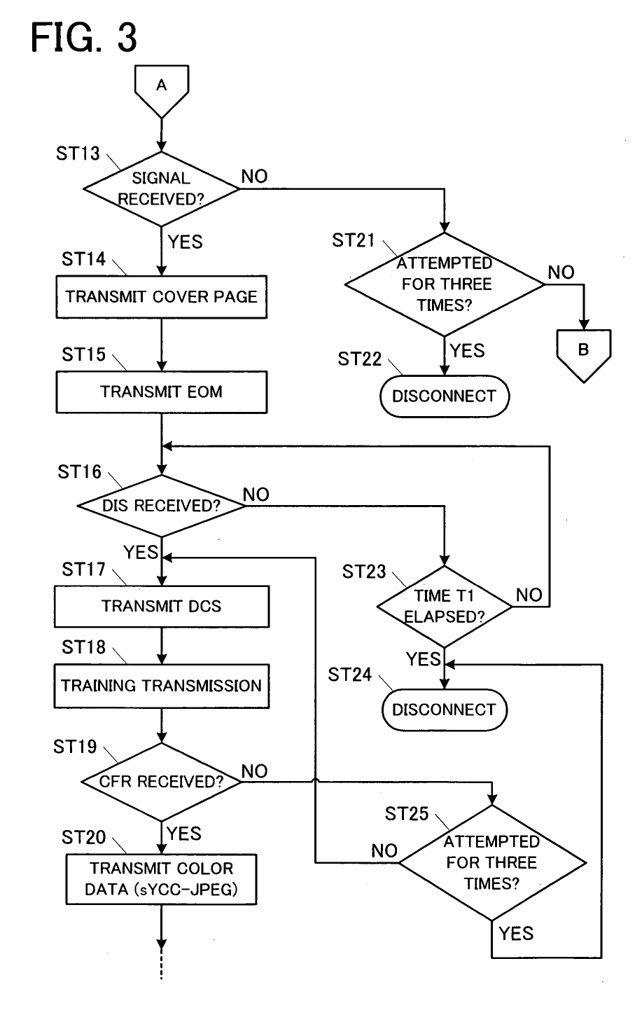

Next, referring to FIGS. 2 and 3, the transmission process of the multifunction peripheral of the present embodiment will be described. When entering into the transmission process routine, first, in step ST1, it is determined whether or not transmission data is color data. When the data is color data, the process proceeds to step ST2. Meanwhile, when the data is not color data, the process proceeds to step ST5. In step ST2, it is determined whether or not the color space is the sYCC color space. When the color space is the sYCC color space, the process proceeds to step ST3. Meanwhile, when the color space is another color space, the process proceeds to step ST5.

In step ST3, it is determined whether or not to form a cover page from the additional information FJ3 of the sYCC-JPEG file FJ, the information included in the image file. The determination process for the cover page is carried out in accordance with an input operation of an operator. When forming a cover page, the process proceeds to step ST4. Meanwhile, when not forming a cover page, the process proceeds to step ST5. In step ST5, a dial is made. Then, the process proceeds to step ST6. In step ST6, a calling tone signal (CNG) is transmitted. Next, the process proceeds to step ST7.

In step ST7, it is determined whether or not a calling tone signal has been received. When a calling tone signal has been received, the process proceeds to step ST8. Meanwhile, when no calling tone signal has been received, the process proceeds to step ST12. In step ST12, it is determined whether or not a time T1 has elapsed (a timer T1 is started as the transmission of the CNG signal). Until the time T1 elapses, the process returns to step ST6, and the CNG signal is transmitted. Meanwhile, when the time T1 elapses, a dial is made again (redialing).

In step ST8, it is determined whether or not a Digital Identification Signal (DIS) signal has been received from a terminal that received the CNG signal. When receiving a DIS signal, the process proceeds to step ST9. Meanwhile, when a DIS signal has not been received, the process returns to step ST12, and until the time T1 elapses, the process returns to step ST6 and the CNG signal is transmitted. In step ST9, it is determined whether or not the receiving device has a color receiving ability in accordance with the DIS signal. When the receiving device has a color receiving ability, the process proceeds to step ST10. Meanwhile, when the receiving device does not have the color receiving ability, the process proceeds to a conventional FAX protocol process.

In step ST10, a Digital Command Signal (DCS) signal is transmitted. Next, the process proceeds to step ST11. In step ST11, a training transmission begins. Next, the process proceeds to step ST13. In step ST13, it is determined whether or not a Confirmation to Receive (CFR) signal has been received. When it is determined that the CFR signal has been received, the process proceeds to step ST14. Meanwhile, when the CFR signal has not been received, the process proceeds to step ST21. In step ST21, it is determined whether or not the training transmission has been attempted three times. When the training transmission has not been attempted for three times, the process proceeds to step ST10. Meanwhile, when the training transmission has been attempted for three times, the process proceeds to step ST22, and the connection is disconnected.

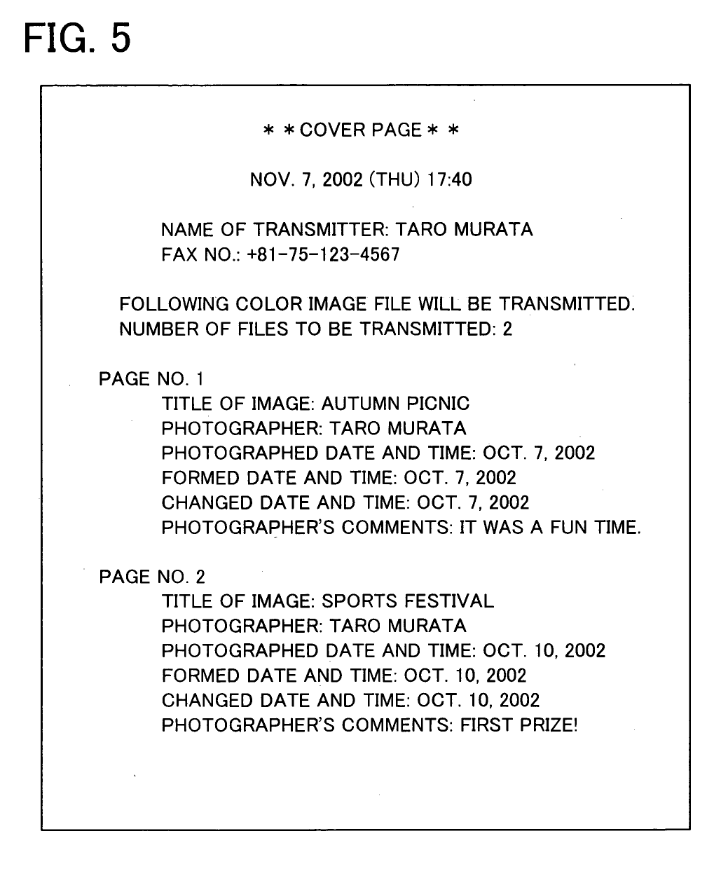

In step ST14, a cover page is transmitted. In this case, a monochrome image transmission is carried out. FIG. 5 shows an example of a cover page formed and transmitted. Next, the process proceeds to step ST15. In step ST15, an End Of Message (EOM) signal (post message) is transmitted. Then, the process proceeds to step ST16. In step ST16, it is determined whether or not a DIS signal has been received. When a DIS signal has been received, the process proceeds to step ST17. Meanwhile, when a DIS signal has not been received, the process proceeds to step ST23. In step ST23, it is determined whether or not the time T1 has elapsed. Until the time T1 elapses, the process returns to step ST16, and waits until receiving a DIS signal. Meanwhile, when the time T1 elapses, the process proceeds to step ST24, and the connection is disconnected. In step ST17, a DCS signal is transmitted. Then, the process proceeds to step ST18. In step ST18, a training transmission is carried out. In steps ST16 through ST18, processes that are the same as the processes of steps ST8 through ST11 are carried out to start the processes again from the reception of a DIS signal to transmit a color image. Next, the process proceeds to step ST19.

In step ST19, it is determined whether or not a CFR signal has been received from the destination. When receiving a CFR signal, the process proceeds to step ST20. Meanwhile, when not receiving a CFR signal, the process proceeds to step ST25. In step ST25, without receiving the CFR signal, it is determined whether or not the transmission of the DCS signal in step ST17 and the training transmission in step ST18 have been attempted for three times. When the processes have not been attempted for three times, the process returns to step ST17. Then, the transmission of the DCS signal and the training transmission are carried out again. When the training transmission is attempted for three times without receiving the CFR signal, the process proceeds to step ST24, and the connection is disconnected to end the process. In step ST20, color data (sYCC-JPEG) is transmitted.

What is claimed is:

1. An image transmitting device comprising:
means for scanning an image of a document;
means for storing scanned image data;
means for connecting to a communication medium;
means for extracting various pieces of information other than image data included in the stored image data; and
means for controlling to convert the extracted various pieces of information into extracted image data and to transmit the extracted image data along with the scanned image data as transmission image data.

2. An image transmitting device comprising:
means for scanning an image of a document;
means for storing scanned sYCC-Joint Photographic Experts Group (JPEG) image data;
means for connecting to a communication line;
means for extracting various pieces of information other than image data included in the stored sYCC-JPEG color image data; and
means for controlling to convert the extracted various pieces of information into extracted image data and to transmit the extracted image data along with the image data as transmission image data.

3. The image transmitting device according to claim 1, wherein when transmitting a multiple page image all at once, data regarding a number of pages of the multiple page image is included in the extracted information.

4. The image transmitting device according to claim 2, wherein when transmitting a multiple page image all at once, data regarding a number of pages of the multiple page image is included in the extracted information.

5. The image transmitting device according to claim 1, wherein the image is of a color original document.

6. The image transmitting device according to claim 2, wherein the image is of a color original document.

7. The image transmitting device according to claim 1, wherein the image data includes a photographed time.

8. The image transmitting device according to claim 2, wherein the image data includes a photographed time.

9. An image transmitting device comprising:
a scanner that scans an image of a document;
a memory that stores scanned image data;
a controller that connects to a communication medium;
an extracting unit that extracts various pieces of information other than image data included in the stored image data; and
a converter that converts the extracted various pieces of information into extracted image data and transmits the extracted image data along with the scanned image data as transmission image data.

10. An image transmitting device comprising:
a scanner that scans an image of a document;
a memory that stores scanned sYCC-Joint Photographic Experts Group (JPEG) image data;
a controller that connects to a communication line;
a extracting unit that extracts various pieces of information other than image data included in the stored sYCC-JPEG color image data; and
a converter that converts the extracted various pieces of information into extracted image data and transmits the extracted image data along with the scanned SYCC-JPEG image data as transmission image data.

11. The image transmitting device according to claim 9, wherein when transmitting a multiple page image all at once, data regarding a number of pages of the multiple page image is included in the extracted information.

12. The image transmitting device according to claim 10, wherein when transmitting a multiple page image all at once, data regarding a number of pages of the multiple page image is included in the extracted information.

13. The image transmitting device according to claim 9, wherein the image is of a color original document.

14. The image transmitting device according to claim 10, wherein the image is of a color original document.

15. The image transmitting device according to claim 9, wherein the image data includes a photographed time.

16. The image transmitting device according to claim 10, wherein the image data includes a photographed time.

17. A method for transmitting an image comprising:
scanning an image of a document;
storing scanned image data;
connecting to a communication medium;
extracting various pieces of information other than image data included in the stored image data; and
controlling to convert the extracted various pieces of information into extracted image data and to transmit the extracted image data along with the image data as transmission image data.

18. The method for transmitting an image according to claim 17, further comprising when transmitting a multiple page image all at once, including data regarding a number of pages of the multiple page image in the extracted information.

19. The method for transmitting an image according to claim 17, further comprising transmitting an image of a color original document.

20. The method for transmitting an image according to claim 17, further comprising including a photographed time as the image data.
